(19) United States
(12) Patent Application Publication
(10) Pub. No.: US 2007/0068310 A1
(43) Pub. Date: Mar. 29, 2007

(54) Steering column device for steering wheel of vehicle

(76) Inventor: Koji Arihara, Kosai-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/512,974

(22) Filed: Aug. 30, 2006

(30) Foreign Application Priority Data
Sep. 1, 2005 (JP) P2005-253832

(51) Int. Cl. B62D 1/18

(52) U.S. Cl. 74/493

(57) ABSTRACT

A steering column device includes a movable column jacket telescopically supported to a stationary column jacket, a tilt head supported to the movable column jacket so as to be capable of oscillating, a telescopic-lock unit for locking the movable column jacket, a tilt-lock unit for locking the tilt head, an operating lever supported to the tilt head so as to be capable of oscillating and a motion transmitting mechanism for transmitting an operation of the operating lever to the telescopic-lock unit and the tilt-lock unit. The motion transmitting mechanism has a direction-change link rotatably supported to the movable column jacket. Further, a position of a connect pin for connecting the change-direction link to the operating lever is substantially above an oscillation center shaft of the tilt head.

### BACKGROUND OF THE INVENTION

1. Field of the Invention

The present invention relates to a steering column device for a steering wheel of a vehicle, which has a function enabling a position of a steering wheel and its tilt angle to be adjusted corresponding to driver's figure and preference for easy driving.

2. Description of the Related Art

In prior art, Japanese Patent Application Laid-open No. 2004-42878 discloses a steering column device having the above-mentioned function. As shown in FIGS. 1 and 2, this steering column device 100 includes a stationary column jacket 101 fixed to a vehicle body (not shown), a movable column jacket 102 movable in an axial direction C of the stationary column jacket 101 and telescopically supported to a distal side of the same jacket 101, a tilt head 103 supported to a distal end of the movable column jacket 102 so as to be capable of oscillating about a pivot shaft 110 and a column shaft 104 rotatably arranged in the stationary column jacket 101, the movable column jacket 102 and the tilt head 103. Additionally, the column shaft 104 is adapted so as to be retractable corresponding to both expansion and contraction of the movable column jacket 102 and also capable of oscillating corresponding to the oscillating movement of the tilt head 103. The steering column device 100 further includes a steering wheel (not shown) fixed to a distal end of the column shaft 104 projecting from the tilt head 103, a telescopic-lock unit 111 for locking the movable column jacket 102 to the stationary column jacket 101, a tilt-lock unit 112 for locking the tilt head 103 to the movable column jacket 102, an operating lever 114 supported to the tilt head 103 so as to be capable of oscillating about a pivot shaft 113 as a fulcrum and a motion transmitting mechanism 115 for transmitting a driver's operation on the operating lever 114 to the telescopic-lock unit 111 and the tilt-lock unit 112.

The motion transmitting mechanism 115 includes a pusher plate 116 fixed on the other end of the operating lever 114, a pusher rod 117 arranged on a moving trace of the pusher plate 116 and supported to the movable column jacket 102 and a clamp shaft 118 rotated by the pusher rod 117 moving and supported to the movable column jacket 102. With this constitution, the motion transmitting mechanism 115 is adapted so as to allow the telescopic-lock unit 111 to be displaced between its unlocked state and the locked state through the clamp shaft 118. Additionally, the motion transmitting mechanism 115 includes a projecting piece 114 formed integrally with the operating lever 114, allowing the tilt-lock unit 112 to be displaced between its unlocked state and the locked state.

In the above-mentioned structure, when moving the operating lever 114 from a lever-locking position (i.e. position with an imaginary line of FIG. 1) to a lever-releasing position (i.e. position with a solid like of FIG. 1), this displacement is transmitted to the telescopic-lock unit 111 and the tilt-lock unit 112 through the motion transmitting mechanism 115, so that the telescopic-lock unit 111 and the tilt-lock unit 112 are brought into their respective unlocked states. When applying an external force on the steering wheel (not shown) in order to move it in a desired direction while maintaining the operating lever 114 in the lever releasing position, the movable column jacket 102 moves in the direction C in relation to the stationary column jacket 101 and additionally, the tilt head 103 oscillates in relation to the movable column jacket 102. In this way, since the telescopic position of the movable column jacket 102 and the tilt angle of the tilt head 103 change, it becomes possible to adjust a fore-and-aft position of the steering wheel and its tilt angle to its desired posture. After completing the adjustment, it is performed to bring back the operating lever 114 from the lever releasing position to the lever locking position. Consequently, the displacement of the operating lever 114 is transmitted to the telescopic-lock unit 111 and the tilt-lock unit 112 through the motion transmitting mechanism 115, so that both of the units 111, 112 are brought into their locked states.

According to the conventional example mentioned above, a driver can perform one adjustment (i.e. telescopic adjustment) in the fore-and-aft position of the steering wheel and another adjustment (i.e. tilt-adjustment) in the tilt angle of the steering wheel by operating the single operating lever 114. Furthermore, since the operating lever 114 is attached to the tilt head 103, the position of the operating lever 114 in relation to the steering wheel is constant irrespective of the fore-and-aft position and the tilt angle of the steering wheel, as shown with solid lines and imaginary lines of FIG. 2. Therefore, it can be said that the above-mentioned steering column device has high operability.

### SUMMARY OF THE INVENTION

In the above-mentioned steering column device 100, however, when an oscillation angle (i.e. tilt angle) of the tilt head 103 is changed, a working point where the pusher plate 116 presses the pusher rod 117 changes corresponding to the change in the tilt angle, as shown with solid lines and imaginary lines of FIG. 2. This means that a driver's operating physical force in operating the operating lever 114 is unsettled due to such a positional variation about the working point where the pusher plate 116 presses the pusher rod 117, causing a problem of inferior operability of the operating lever 114. Additionally, even if a driver's operating physical force is constant, the steering column device 100 produces a variation in the operating stroke of the operating lever 114. Also in this regard, it is difficult to say that the steering column device 100 has high operability. It is further noted that the telescopic-lock unit 111 is arranged in the stationary column jacket 101. This means that a stroke absorbing member has to be arranged between the clamp shaft 118 and the telescopic-lock unit 111 in order to absorb an axial stroke of the column shaft 104 due to a driver's telescopic operation. As a result, the number of components is increased and the structure of the steering column device 100 is complicated, disadvantageously.

In order to solve the above-mentioned problems, an object of the present invention is to provide a steering column device which is superior in the operability of an operating lever in the respect that the position of an operating lever in relation to a steering wheel is constant irrespective of an oscillation angle of a tilt head and additionally, there is no change in both operating physical force and operating stroke about the operating lever irrespective of the oscillation angle of the tilt head.

In order to attain the above object, according to an aspect of the present invention, there is provided a steering column device for a steering wheel of a vehicle, comprising: a stationary column jacket fixed to the vehicle body; a movable column jacket telescopically supported to a distal side of the stationary column jacket, the movable column jacket being movable in an axial direction of the stationary column jacket; a tilt head supported to a distal end of the movable column jacket, the tilt head being capable of oscillating about an oscillation center shaft; a column shaft rotatably arranged in the stationary column jacket, the movable column jacket and the tilt head, the column shaft being supported so as to be retractable corresponding to a telescopic motion of the movable column jacket and also capable of oscillating corresponding to an oscillation of the tilt head; a telescopic-lock unit configured to lock the movable column jacket to the stationary column jacket; a tilt-lock unit configured to lock the tilt head to the movable column jacket; an operating lever supported to the tilt head so as to be capable of oscillating between a lever locking position and a lever releasing position; and a motion transmitting mechanism configured to transmit an operation of the operating lever to the telescopic-lock unit and the tilt-lock unit, the motion transmitting mechanism having an input link rotatably supported to the movable column jacket, wherein a connecting position between the input link and the operating lever is substantially above the oscillation center shaft; wherein a displacement of the operating lever from the lever locking position to the lever releasing position is transmitted to the telescopic-lock unit and the tilt-lock unit into their unlocked states through the motion transmitting mechanism, whereby an axial position of the movable column jacket and a tilt angle of the tilt head can be adjusted.

With the above configuration, since the operating lever also moves while following the tilt head when oscillating the tilt head, there is no change in the position of the operating lever in relation to the tilt head. Additionally, since the input link connected to the operating lever does not rotate even when the tilt head oscillates, both an operating physical force and an operating stroke about the operating lever do not change. From above, the steering column device of this embodiment is superior in the operability of the operating lever since its position in relation to the steering wheel is constant irrespective of the tilt angle of the tilt head and additionally, the operating physical force and the operating stroke about the operating lever do not change irrespective of the tilt angle of the tilt head.

Further, as the position of the motion transmitting mechanism in relation to the operating lever does not change by an oscillation of the tilt head, there is no possibility that the tilt-lock unit and the telescopic-lock unit move in a direction to loose the unlocked state and the locked state, improving the reliability of the steering column device.

The motion transmitting mechanism may comprise a first motion transmitting part for transmitting the operation of the operating lever to the telescopic-lock unit and a second motion transmitting part for transmitting the operation of the operating lever to the tilt-lock unit.

With the above configuration, the first motion transmitting part for the telescopic-lock unit may comprise only a plurality of link members supported to the movable column jacket, as well as the input link.

Further, it is possible to simplify the constitution of the motion transmitting mechanism.

The telescopic-lock unit may be connected to an output link of the link members of the first motion transmitting part and arranged to be movable to the stationary column jacket.

With the above configuration, since an operative motion of the operating lever can be transmitted to the telescopic-lock unit certainly, it is possible to improve reliability in the operation of the operating lever. Additionally, since there is no need of providing the link members with a stroke absorbing member for absorbing an axial stroke of the column shaft, it is possible to reduce the number of components and simplify the structure of the motion transmitting mechanism.

The telescopic-lock unit may comprise a rotating shaft rotated by the output link of the first motion transmitting part, a cam assembly for locking the movable column jacket with a rotation of the rotating shaft and a shaft holding plate for preventing the rotating shaft from inclining.

With the above configuration, since the rotating shaft can be prevented from inclining, the rotating shaft can be rotated by a movement of the first motion transmitting part certainly and smoothly, improving the operability about the operating lever.

The telescopic-lock unit may comprise a rotating shaft rotated by the output link of the motion transmitting mechanism and a cam assembly for locking the movable column jacket with a rotation of the rotating shaft, and the movable column jacket has a shaft holding hole into which a distal end of the rotating shaft is inserted and which prevents the rotating shaft from inclining.

With the above configuration, since the rotating shaft can be prevented from inclining, it can be rotated by a movement of the motion transmitting mechanism certainly and smoothly, improving the operability of the operating lever while reducing the number of the components of the telescopic-lock unit.

The cam assembly may include a disc cam and a rectangular cam in contact with the disc cam, the disc cam and the rectangular cam having respective contact surfaces consisting of corrugated cam faces, and the stationary column jacket may have slide chambers formed to accommodate the disc cam and the rectangular cam slidably in the axial direction of the stationary column jacket.

With the above configuration, since the disc cam and the rectangular cam having respective contact surfaces consisting of corrugated cam faces, the rectangular cam can act on the movable column jacket depending on a relative rotational position between the disc cam and the rectangular. Additionally, since the disc cam and the rectangular cam are slidably accommodated in the slide chambers in the stationary column jacket, the operation of the telescopic-lock unit can be ensured irrespective of the position of the movable column jacket in relation to the stationary column jacket.

These and other objects and features of the present invention will become more fully apparent from the following description and appended claims taken in conjunction with the accompany drawings.

### BRIEF DESCRIPTION OF THE DRAWINGS

FIG. 1 is a bottom view of a steering column device in a prior art;

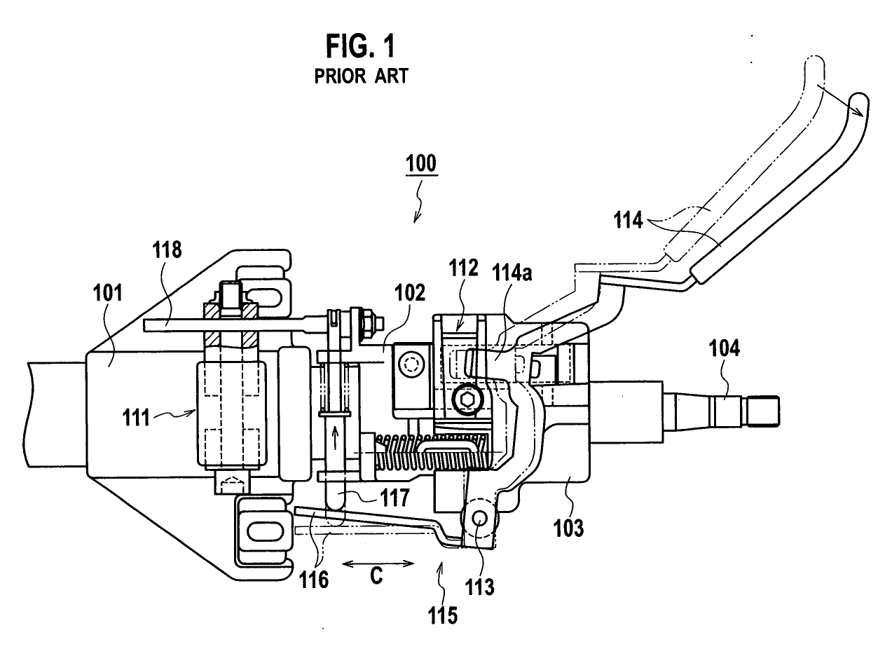

FIG. 2 is a front view of the steering column view of FIG. 1, showing two states where a tilt head is oscillated;

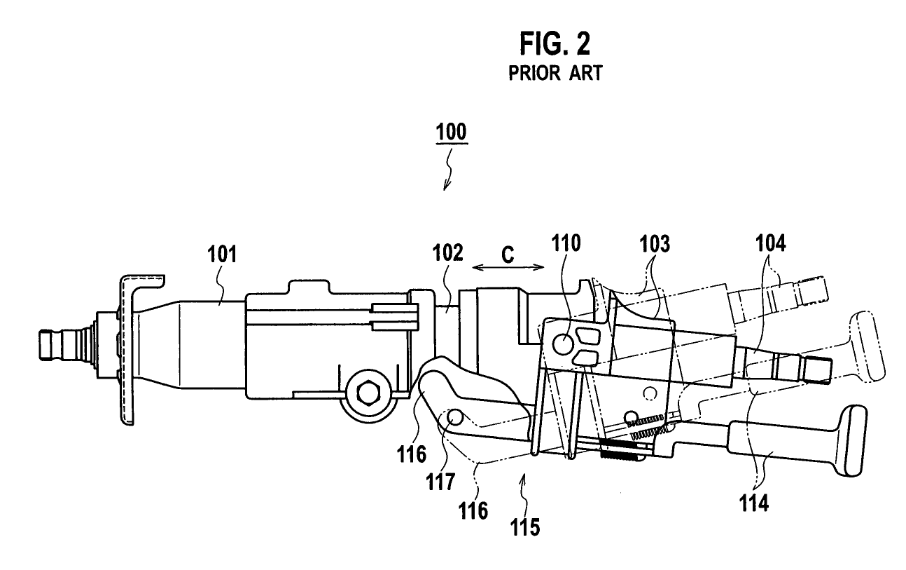

FIG. 3 is a perspective view of a steering column device in accordance with a first embodiment of the present invention;

FIG. 4 is a front view of the steering column device in accordance with the first embodiment of the present invention;

FIG. 5 is a bottom view of the steering column device in accordance with the first embodiment of the present invention;

FIG. 6 is a schematic front view of a tilt-lock unit of the steering column device, showing the first embodiment of the present invention;

FIG. 7 is a sectional view taken along a line A-A of FIG. 4, showing the first embodiment of the present invention;

FIG. 8 is a front view of the steering column device in its locked state, showing the first embodiment of the present invention;

FIG. 9 is a perspective view of a steering column device in accordance with a second embodiment of the present invention;

FIG. 10 is a front view of the steering column device in accordance with the second embodiment of the present invention;

FIG. 11 is a bottom view of the steering column device in accordance with the second embodiment of the present invention; and

FIG. 12 is a sectional view taken along a line B-B of FIG. 10, showing the second embodiment of the present invention.

### DETAILED DESCRIPTION OF THE INVENTION

Referring to accompanying drawings, embodiment of the present invention will be described below.

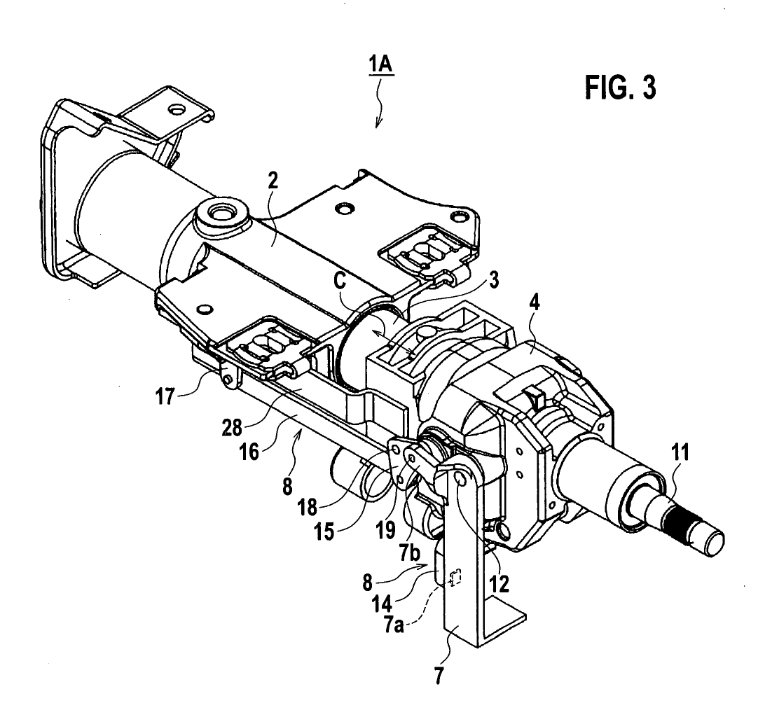

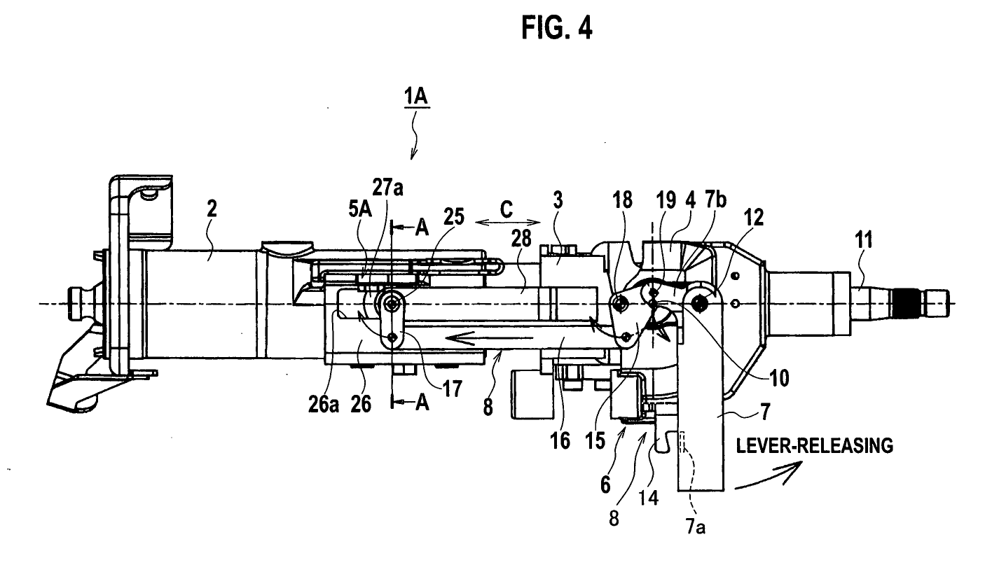

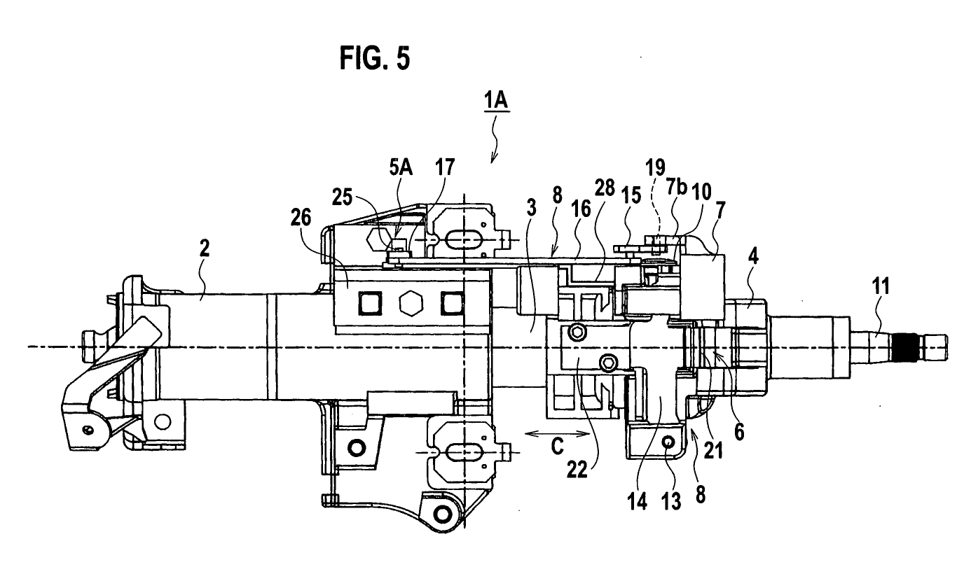

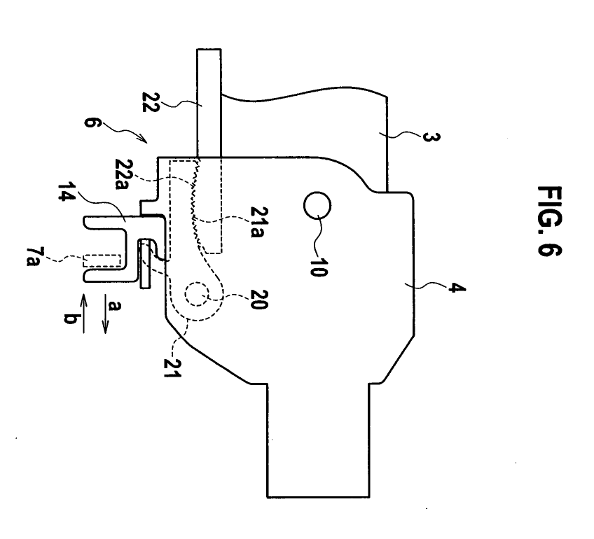

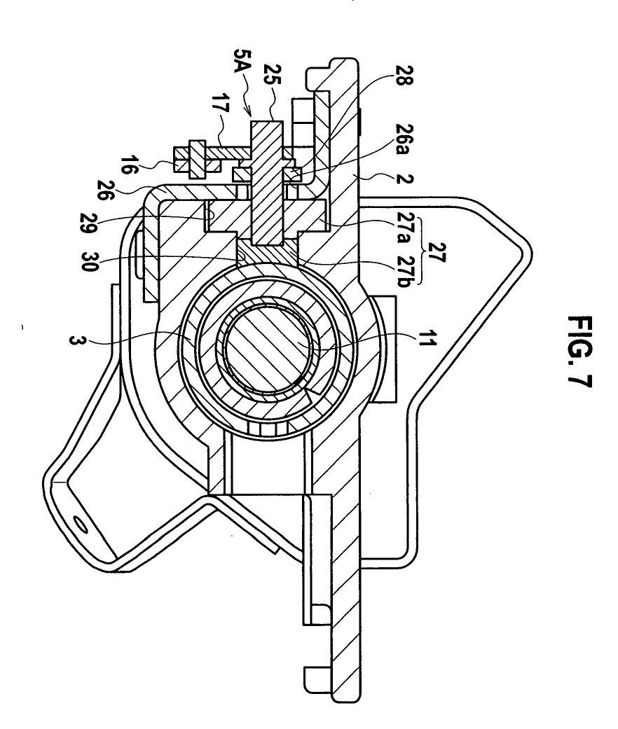

FIGS. 3 to 7 show a first embodiment of the present invention. FIG. 3 is a perspective view of a steering column device. FIG. 4 is a front view of the steering column device. FIG. 5 is a bottom view of the steering column device. FIG. 6 is a schematic front view of a tilt-lock unit of the steering column device. FIG. 7 is a sectional view taken along a line A-A of FIG. 4.

As shown in FIGS. 3 to 5, a steering column device 1A includes a stationary column jacket 2 fixed to a vehicle body (not shown), a movable column jacket 3 which is movable in an axial direction C of the stationary column jacket 2 and telescopically supported to a distal end of the stationary column jacket 2 and a tilt head 4 which is arranged at a distal end of the movable column jacket 3 so as to be capable of oscillating about an oscillation center shaft 10.

A column shaft 11 is arranged in the stationary column jacket 2, the movable column jacket 3 and the tilt head 4. The column shaft 11 is rotatable, retractable (i.e. capable of expansion and contraction) corresponding to motions of the movable column jacket 3 and capable of oscillating corresponding to an oscillating (or tilting) motion of the tilt head 4. The column shaft 11 has its distal end projecting from a distal end of the tilt head 4. A steering wheel (not shown) is fixed to this projecting portion of the column shaft 11.

The steering column device 1A includes a telescopic-lock unit 5A which locks the movable column jacket 3 in relation to the stationary column jacket 2 so as to be immovable in an axial direction C, a tilt-lock unit 6 which locks the tilt head 4 so as to be incapable of oscillating against the movable column jacket 3, a single operating lever 7 for operating the telescopic-lock unit 5A and the tilt-lock unit 6 and a motion transmitting mechanism 8 for transmitting operative motions of the operating lever 7 to the telescopic-lock unit 5A and the tilt-lock unit 6.

The operating lever 7 is supported to the tilt head 4 so as to be capable of oscillating about an oscillation shaft 12 as a fulcrum. The operating lever can move between a lever locking position and a lever releasing position. In view of a driver, a farther position corresponds to the lever locking position, while a closer position corresponds to the lever releasing position.

The motion transmitting mechanism 8 consists of one (first) motion transmitting part for transmitting a motion of the operating lever 7 to the tilt-lock unit 6 and another (second) motion transmitting part for transmitting a motion of the operating lever 7 to the telescopic-lock unit 5A. The first motion transmitting part for the tilt-lock unit 6 is provided in the tilt head 4 and comprises a projecting piece 7a formed integrally with the operating lever 7 and an oscillation link 14 engaged with the projecting piece 7a. The oscillation link 14 is supported on the tilt head 4 so as to be capable of oscillating about an oscillation fulcrum 13 (see FIG. 5) as a pivot center. Thus, the oscillation link 14 allows the tilt-lock unit 6 to be displaced between its unlocked state and the locked state.

The second motion transmitting part for the telescopic-lock unit 5A is provided in the movable column jacket 3 and comprises a change-direction link 15 forming an input link coupled to an arm portion 7b of the operating lever 7 with a connect pin 19, a linear link 16 having one end connected to the change-direction link 15 through a pin and a rotary link 17 forming an output link connected to the other end of the linear link 16. Thus, the rotary link 17 allows the telescopic-lock unit 5A to be displaced between its unlocked state and the locked state. The change-direction link 15 is pivotally supported through an oscillation shaft 18 on the movable column jacket 3. The position of the connect pin 19 for connecting the change-direction link 15 to the operating lever 7 is substantially above the oscillation center shaft 10 of the tilt head 4 in side view of the steering column device 1A.

As shown in FIGS. 5 and 6, the tilt-lock unit 6 includes a lock tooth 21 rotatably supported on the tilt head 4 through a support shaft 20 and a ratchet member 22 fixed to the movable column jacket 3. The lock tooth 21 and the ratchet member 22 have circular teeth portions 21a, 22a formed on an identical circumference centering on the oscillation center shaft 10 of the tilt head 4, respectively. The lock tooth 21 is urged in a direction to engage the circular teeth portions 21a, 22a with each other.

That is, when the operating lever 7 moves from the lever locking position to the lever releasing position, this displacement causes the oscillation link 14 to oscillate in a direction a of FIG. 6, so that the circular teeth portion 21a of the lock tooth 21 is separated from the circular teeth portion 22a of the ratchet member 22, establishing the above-mentioned unlocked state. While, when the operating lever 7 moves from the lever releasing position to the lever locking position, this displacement causes the oscillation link 14 to oscillate in a direction b of FIG. 6, establishing the above-mentioned locked state where the circular teeth portion 21a of the lock tooth 21 is engaged with the circular teeth portion 22a of the ratchet member 22.

As shown in FIG. 7, the telescopic-lock unit 5A includes a rotating shaft 25 fixed to a distal end of the rotary link 17, a stationary plate 26 having a long hole 26a into which a distal end of the rotating shaft 25 is inserted, a cam assembly 27 carried by the rotating shaft 25 inserted into the long hole 26a in the stationary plate 26 and a shaft holding plate 28 arranged outside the stationary plate 26 to hold the rotating shaft 25 rotatably.

In the stationary plate 26, the stationary jacket 2 is formed with a first slide chamber 29 extending in the axial direction C of the movable column jacket 3 and having a large width and a second slide chamber 30 also extending in the axial direction C of the movable column jacket 3 and having a small width. The second slide chamber 30 opens to an outer circumferential surface side of the movable column jacket 3. The cam assembly 27 is accommodated in the first slide chamber 29 and comprises a disc cam 27a fitted to the rotating shaft 25 and a rectangular cam 27b accommodated in the second slide chamber 30 to allow a portion of the distal end of the rotating shaft 25 to be inserted. Both contact surfaces of the disc cam 27a and the rectangular cam 27b constitute corrugated cam faces respectively. Thus, depending on a relative rotational position between the cam 27a and the cam 27b, it can push the movable column jacket 3 or cannot push it. When the movable column jacket 3 is moved in relation to the stationary column jacket 2 in the axial direction C, the disc cam 27a and the rectangular cam 27b slide in the first slide chamber 29 and the second slide chamber 30. Then, the disc cam 27a rotates in the first slide chamber 29 while following the rotation of the rotating shaft 25. On the contrary, the rectangular cam 27b does not rotate in the second slide chamber 30 in spite of the rotation of the rotating shaft 25. Consequently, the relative rotational position between the disc cam 27a and the rectangular cam 27b is varied.

The shaft holding plate 28 has its one end fixed to the movable column jacket 3. The shaft holding plate 28 is arranged on the outer circumference of the movable column jacket 3 along the axial direction C, while the other end of the shaft holding plate 28 holds the rotating shaft 25 so that it does not slant by the shaft holding plate 28 integrally moving with the movable column jacket 3.

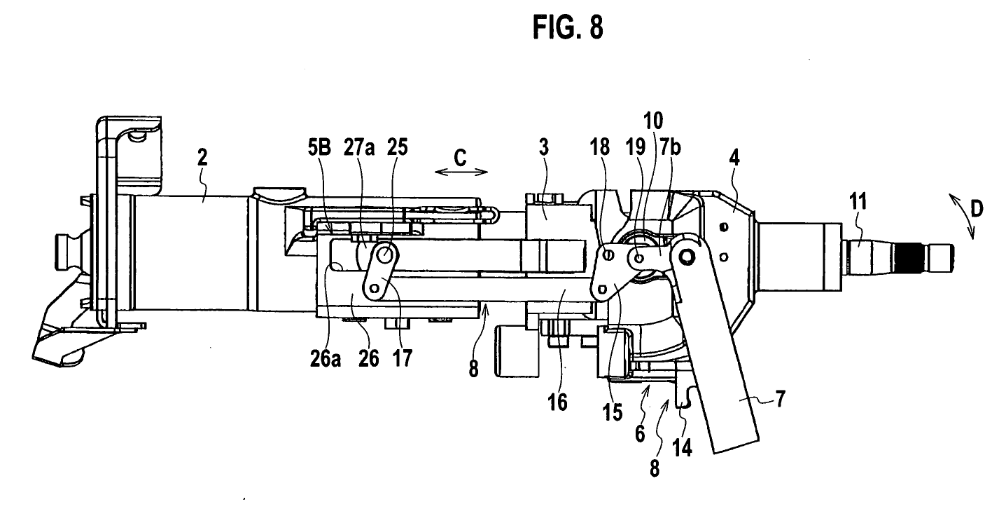

That is, when the operating lever 7 moves from the lever locking position to the lever releasing position, this displacement causes the change-direction link 15, the linear link 16 and the rotary link 17 to be displaced in a direction of arrow of FIG. 4, in this order. As a result, the rotating shaft 25 rotates as shown in FIG. 8, so that the relative rotational position between the disc cam 27a and the rectangular cam 27b is varied. This change in the relative rotational position between the disc cam 27a and the rectangular cam 27b causes the rectangular cam 27b not to press the movable column jacket 3, realizing the unlocked state. When the operating lever 7 moves from the lever releasing position to the lever locking position, this displacement causes the change-direction link 15, the linear link 16 and the rotary link 17 to be displaced in the opposite direction to the arrow of FIG. 4, in this order. As a result, the rotating shaft 25 rotates reversely, so that the relative rotational position between the disc cam 27a and the rectangular cam 27b returns to the original state. Due to this change in the relative rotational position between the disc cam 27a and the rectangular cam 27b, there is established the locked state where the rectangular cam 27b presses the outer circumferential surface of the movable column jacket 3.

Next, we explain a telesco/tilt adjustment work for the above-mentioned steering column device 1A. Assume, the operating lever 7 is in the lever locking position. In this state, when a driver operates the operating lever 7 from the lever locking position (i.e. a position shown with solid lines of FIGS. 3 and 4) to the lever releasing position, this displacement of the operating lever 7 is transmitted to the telescopic-lock unit 5A and the tilt-lock unit 6 through the motion transmitting mechanism 8, so that both of the units 5A, 6 are brought into their unlocked states. When applying an external force on a steering wheel (not shown) in order to move it in a desired direction while maintaining the operating lever 7 in the lever releasing position, the movable column jacket 3 moves in the direction C in relation to the stationary column jacket 2 and additionally, the tilt head 4 swings in an upward-and-downward direction D in relation to the stationary column jacket 2. In this way, since the telescopic position of the movable column jacket 3 and the tilt angle of the tilt head 4 change, it becomes possible to adjust both fore-and-aft position and tilt angle of the steering wheel (not shown) to its desired posture. After completing the adjustment, it is performed to bring back the operating lever 7 from the lever releasing position to the lever locking position. Consequently, the displacement of the operating lever 7 is transmitted to the telescopic-lock unit 5A and the tilt-lock unit 6 through the motion transmitting mechanism 8, so that both of the units 5A, 6 are brought into their locked states.

When oscillating the tilt head 4 in the course of the telescopic tilt adjustment, the operating lever 7 also moves while following the tilt head 4. Thus, there is no change in the position of the operating lever 7 in relation to the tilt head 4. Additionally, as the connecting position between the change-direction link 15 and the operating lever 7 (i.e. the position of the connect pin) is generally above the oscillation center shaft 10, the change-direction link 15 connected to the operating lever 7 does not rotate in spite of the tilt head's oscillation. Accordingly, the connecting position of the operating lever 7 is not displaced, so that both an operating physical force and an operating stroke about the same lever 7 do not change. From above, the steering column device of this embodiment is superior in the operability of the operating lever 7 since its position in relation to the steering wheel (not shown) is constant irrespective of the tilt angle of the tilt head 4 and additionally, the operating physical force and the operating stroke about the operating lever 7 do not change irrespective of the tilt angle of the tilt head 4. Further, as the position of the motion transmitting mechanism 8 in relation to the operating lever does not change by the oscillation of the tilt head 4, there is no possibility that the tilt-lock unit 6 and the telescopic-lock unit 5A move in a direction to loose the unlocked state and the locked state, improving the reliability of the steering column device of this embodiment.

According to the first embodiment, since the motion transmitting system of the motion transmitting mechanism 8 to the telescopic-lock unit 5A consists entirely of link members: the change-direction link 15 supported to the movable column jacket 3; the linear link 16; and the rotary link 17, it can be said that the motion transmitting mechanism 8 is simple in its structure.

In the first embodiment, since the telescopic-lock unit 5A is connected to the rotary link 17 as being an output link member of the motion transmitting mechanism 8 and movably provided on the stationary column jacket 2, an operative motion of the operating lever 7 can be transmitted to the telescopic-lock unit 5A certainly, improving the reliability in operating the same lever 7. Again, since the telescopic-lock unit 5A is arranged so as to be movable to the stationary column jacket 2 in the axial direction together with the rotary link 17 and the linear link 16, there is no need of providing the above links with a mechanism for absorbing a stroke between the stationary column jacket 2 and the movable column jacket 3, achieving both reduction in the number of components and simplification in the structure.

Additionally, since the telescopic-lock unit 5A of the first embodiment includes the rotating shaft 25 rotated by the rotary link 17 of the motion transmitting mechanism 8, the cam assembly 27 for locking the movable column jacket 3 with the rotation of the rotating shaft 25 and the shaft holding plate 28 for preventing the rotating shaft 25 from inclining, the motion of the motion transmitting mechanism 8 allows the rotating shaft 25 to be rotated certainly and smoothly, improving the operability of the steering column device.

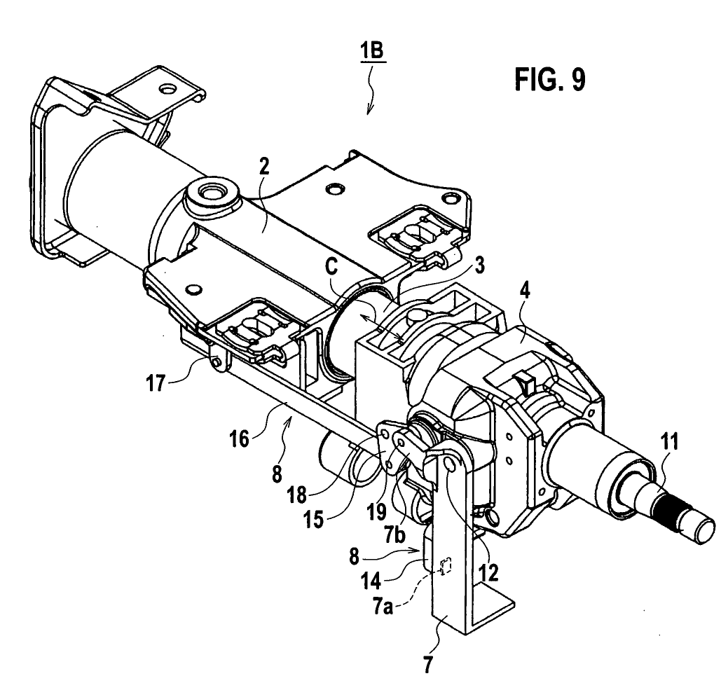

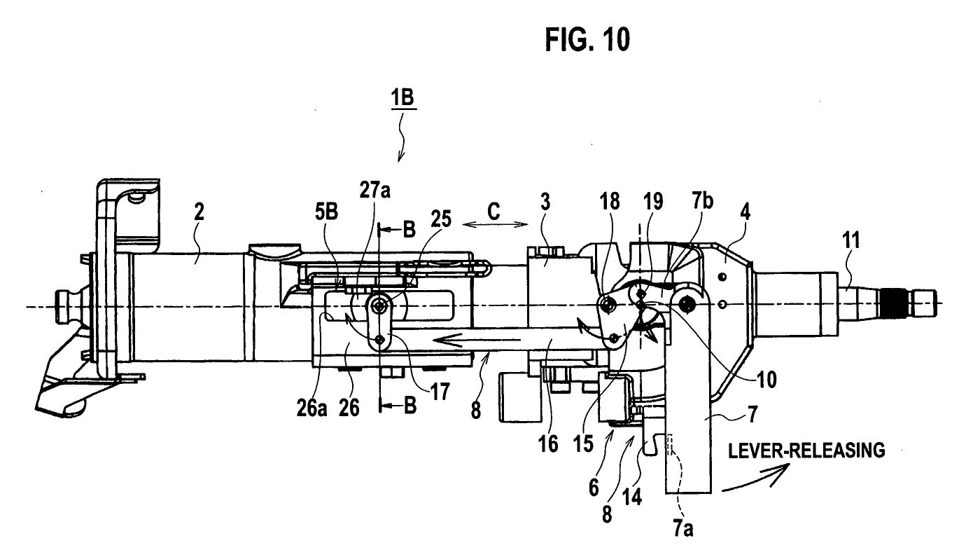

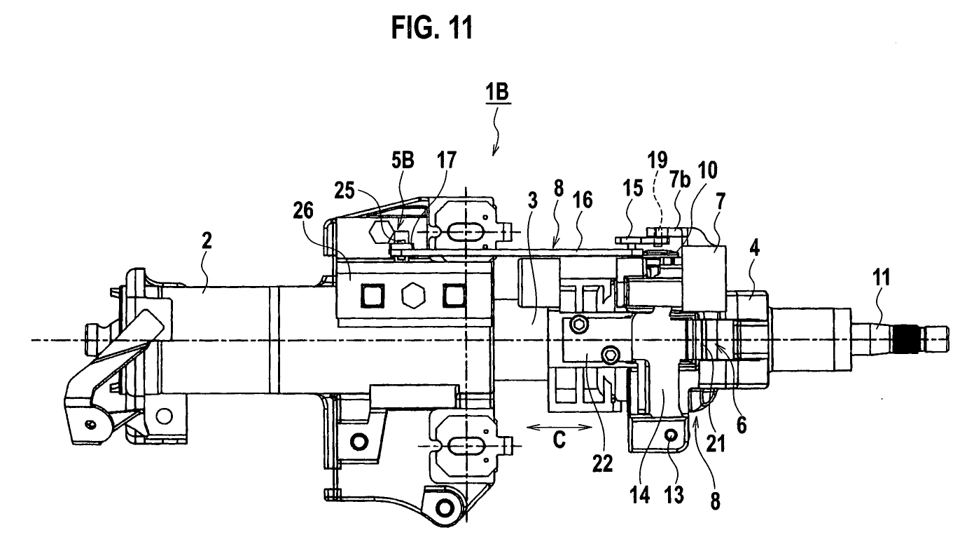

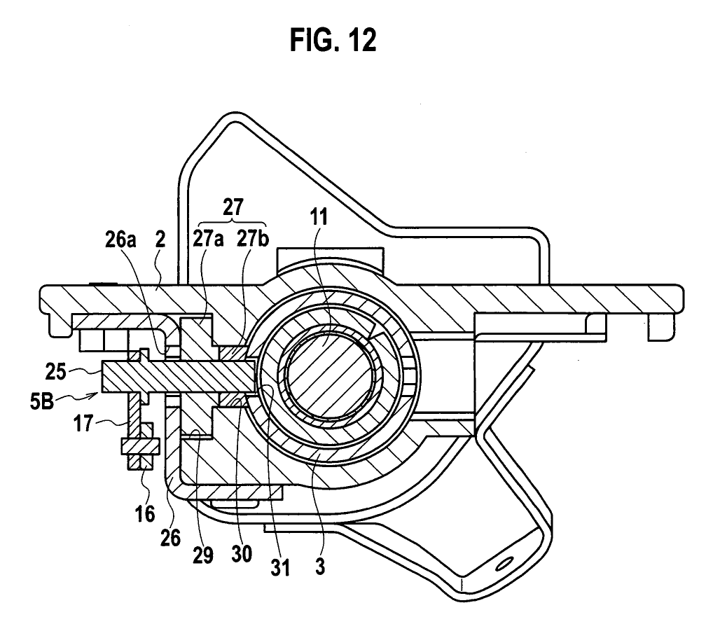

Referring to FIGS. 9 to 12, we describe the second embodiment of the present invention. FIG. 9 is a perspective view of a steering column device of the second embodiment. FIG. 10 is a front view of the steering column device. FIG. 11 is a bottom view of the steering column device. FIG. 12 is a sectional view taken along a line B-B of FIG. 10.

As shown in FIGS. 9 to 11, the steering column device 1B of the second embodiment differs from that of the first embodiment only in the constitution of a telescopic-lock unit 5B. The other constitution of the steering column device 1B is similar to that of the steering column device 1A and therefore, elements identical to the constituents of the steering column device 1A are indicated with the same reference numerals respectively and their descriptions are eliminated. We now describe the telescopic-lock unit 5B with a focus on differences.

As shown in FIG. 12 in detail, the telescopic-lock unit 5 is provided with no shaft holding plate for preventing an inclination of the rotating shaft 25, different from the first embodiment of the present invention. Instead, the movable column jacket 3 is formed with a shaft holding hole 31 extending toward a center of the column shaft 11. The distal end of the rotating shaft 25 is inserted into the shaft holding hole 31, whereby the rotating shaft 25 integrally moves with the movable column jacket 3. That is, the rotating shaft 25 is prevented from inclining by the shaft holding hole 31. As the other constitution of the telescopic-lock unit 5B is identical to that of the first embodiment, elements identical to those of the first embodiment are indicated with the same reference numerals respectively and therefore, their descriptions are eliminated.

Also in the second embodiment, similarly to the first embodiment, the position of the operating lever 7 in relation to a steering wheel (not shown) is constant irrespective of the tilt angle of the tilt head 4. Additionally, since the operating physical force and the operating stroke about the operating lever 7 do not change irrespective of the tilt angle of the tilt head 4, the steering column device of the second embodiment is superior in the operability of the operating lever 7, as well. Further, as the position of the motion transmitting mechanism 8 in relation to the operating lever does not change by the oscillation of the tilt head 4, there is no possibility that the tilt-lock unit 6 and the telescopic-lock unit 5A move in a direction to loose the unlocked state and the locked state, improving the reliability of the steering column device of this embodiment.

According to the second embodiment of the present invention, the telescopic-lock unit 5B includes a rotating shaft 25 as being an output link of the motion transmitting mechanism 8 and a cam assembly 27 for locking the movable column jacket 3 with the rotation of the rotating shaft 25. A distal end of the rotating shaft 25 is inserted into the movable column jacket 3 through the shaft holding hole 31 for preventing the rotating shaft 25 from inclining by the rotating shaft 25 integrally moving with the movable column jacket 3. Accordingly, the motion of the motion transmitting mechanism 8 allows the rotating shaft 25 to be rotated certainly and smoothly. Further, owing to the abolition of the shaft holding plate 20 of the first embodiment, it is possible to reduce the number of components and also possible to improve the operability of the steering column device.

Finally, although the first and second embodiments of the present invention have been described as put forth above, the present invention is not limited to these embodiments and therefore, various changes and modifications may be made within the scope of claims.

What is claimed is:

1. A steering column device for a steering wheel of a vehicle, comprising:
a stationary column jacket fixed to the vehicle body;
a movable column jacket telescopically supported to a distal side of the stationary column jacket, the movable column jacket being movable in an axial direction of the stationary column jacket;
a tilt head supported to a distal end of the movable column jacket, the tilt head being capable of oscillating about an oscillation center shaft;
a column shaft rotatably arranged in the stationary column jacket, the movable column jacket and the tilt head, the column shaft being supported so as to be retractable corresponding to a telescopic motion of the movable column jacket and also capable of oscillating corresponding to an oscillation of the tilt head;
a telescopic-lock unit configured to lock the movable column jacket to the stationary column jacket;
a tilt-lock unit configured to lock the tilt head to the movable column jacket;
an operating lever supported to the tilt head so as to be capable of oscillating between a lever locking position and a lever releasing position; and
a motion transmitting mechanism configured to transmit an operation of the operating lever to the telescopic-lock unit and the tilt-lock unit, the motion transmitting mechanism having an input link rotatably supported to the movable column jacket, wherein a connecting position between the input link and the operating lever is substantially above the oscillation center shaft;
wherein a displacement of the operating lever from the lever locking position to the lever releasing position is transmitted to the telescopic-lock unit and the tilt-lock unit into their unlocked states through the motion transmitting mechanism, whereby an axial position of the movable column jacket and a tilt angle of the tilt head can be adjusted.

2. The steering column device of claim 1, wherein the motion transmitting mechanism comprises a first motion transmitting part for transmitting the operation of the operating lever to the telescopic-lock unit and a second motion transmitting part for transmitting the operation of the operating lever to the tilt-lock unit.

3. The steering column device of claim 2, wherein the first motion transmitting part for the telescopic-lock unit comprises only a plurality of link members supported to the movable column jacket, as well as the input link.

4. The steering column device of claim 3, wherein the telescopic-lock unit is connected to an output link of the link members of the first motion transmitting part and arranged to be movable to the stationary column jacket.

5. The steering column device of claim 4, wherein the telescopic-lock unit comprises a rotating shaft rotated by the output link of the first motion transmitting part, a cam assembly for locking the movable column jacket with a rotation of the rotating shaft and a shaft holding plate for preventing the rotating shaft from inclining.

6. The steering column device of claim 5, wherein
the cam assembly includes a disc cam and a rectangular cam in contact with the disc cam, the disc cam and the rectangular cam having respective contact surfaces consisting of corrugated cam faces, and the stationary column jacket has slide chambers formed to accommodate the disc cam and the rectangular cam slidably in the axial direction of the stationary column jacket.

7. The steering column device of claim 4, wherein
the telescopic-lock unit comprises a rotating shaft rotated by the output link of the motion transmitting mechanism and a cam assembly for locking the movable column jacket with a rotation of the rotating shaft, and
the movable column jacket has a shaft holding hole into which a distal end of the rotating shaft is inserted and which prevents the rotating shaft from inclining.

8. The steering column device of claim 7, wherein
the cam assembly includes a disc cam and a rectangular cam in contact with the disc cam, the disc cam and the rectangular cam having respective contact surfaces consisting of corrugated cam faces, and
the stationary column jacket has slide changes formed to accommodate the disc cam and the rectangular cam slidably in the axial direction of the stationary column jacket.
